(19) United States
(12) Patent Application Publication
(10) Pub. No.: US 2020/0326024 A1
(43) Pub. Date: Oct. 15, 2020

(54) Range of Rapid Couplers with Different Coupler Cartridges

(71) Applicant: Robert Bosch GmbH, Stuttgart (DE)

(72) Inventors: Steffen Knapper, Vaihingen/Enz (DE); Frank Rieckhof, Ludwigsburg (DE); Tanja Ernstmeier, Marbach (DE)

(21) Appl. No.: 16/794,640

(22) Filed: Feb. 19, 2020

(30) Foreign Application Priority Data
Apr. 10, 2019 (DE) 10 2019 205 141.3

(51) Int. Cl. F16L 37/56; F16L 55/115; F16L 3/22

(52) U.S. Cl. CPC F16L 37/56; F16L 3/222; F16L 55/115

(57) ABSTRACT

A range includes a plurality of rapid couplers with each rapid coupler including a coupler housing that has a planar connection face and two coupler cartridges secured in or on the coupler housing. All the coupler housings are configured integrally. All the coupler cartridges are each secured directly in or on the associated coupler housing. The rapid couplers each further include a first working connection, a second working connection, a plurality of securing apertures, and optionally a leakage oil connection all of which are configured in an identical manner with respect to their shape and their relative position inside the associated connection face. At least two rapid couplers of the range have different coupler cartridges. All coupler housings are configured to be arranged with respect to a longitudinal axis beside each other with a constant spacing separation that is identical for all rapid couplers of the range.

This application claims priority under 35 U.S.C. § 119 to patent application no. DE 10 2019 205 141.3, filed on Apr. 10, 2019 in Germany, the disclosure of which is incorporated herein by reference in its entirety.

### BACKGROUND

The disclosure relates to a range of a plurality of rapid couplers according to the preamble of Claim 1.

EP 3 244 114 B1 discloses a rapid coupler which comprises two coupler cartridges, which can be activated by means of a common activation lever. The rapid coupler is provided to install on a valve disc of a valve block comprising a plurality of directional valves. Such rapid couplers are, for example, used in agricultural tractors in order to be able to rapidly produce and release the hydraulic connections to replaceable attachments. Generally, hydraulic hose lines are connected to the corresponding coupler cartridges.

Another rapid coupler is known from U.S. Pat. No. 7,568,502 B2.

From the website which was available at the internet address https://www.fastercouplings.com/couplings-check-valves on 29 Mar. 2019, a large number of coupler cartridges are further known. In the context of the present disclosure, however, only the types are relevant which can be activated by means of an activation lever or which are constructed with push-pull technology.

An advantage of the present disclosure is that the rapid couplers of the range can be combined with each other in a freely selectable manner. This can take place not only with the initial production of a subassembly of rapid couplers. Instead, it is also possible to retrospectively change a rapid coupler of one type for one of another type. In this instance, the rapid couplers are constructed in such a manner that the spacing separation thereof is constructed to be equal to the spacing separation of the valve discs of the valve block, regardless of which coupler cartridge is used.

In spite of this tight structural space, all rapid couplers can be activated independently of each other. Furthermore, all conventional coupler cartridges can be used. Furthermore, the most frequently requested variant by far, that is to say, the rapid coupler of the first subtype, is particularly cost-effective. Furthermore, the coupler housings are constructed in a particularly material-saving manner. The different rapid couplers of the range have many identical components so that, in spite of the different coupler cartridges, they can be produced in a cost-effective manner.

### SUMMARY

According to the independent claim, it is proposed that all coupler housings be constructed integrally, wherein all coupler cartridges are each secured directly in or on the associated coupler housing, wherein the first and second working connections, the securing apertures and, if present, the leakage oil connections are constructed in an identical manner in all rapid couplers with respect to their shape and their relative position inside the associated connection face, wherein at least two rapid couplers of the range have different coupler cartridges, wherein all coupler housings can be arranged with respect to the longitudinal axis beside each other with a constant spacing separation which is identical for all rapid couplers of the range. The spacing separation mentioned is preferably between 100% and 130% of the largest outer diameter of the largest coupler cartridge. The remaining wall thickness between the coupler cartridge and outer surface of the coupler housing is preferably constructed to be as small as technically possible.

Preferably, the center axes of the coupler cartridges when viewed in the direction of the longitudinal axis can be arranged in two parallel alignments when any rapid couplers of the range are combined to form a subassembly. The center axes of the coupler cartridges are preferably orientated parallel with the vertical axis. The securing apertures preferably extend parallel with the vertical axis.

Advantageous developments and improvements of the disclosure are set out in the dependent claims.

There may be provision for the range to comprise a plurality of rapid couplers of the first type, wherein a joining face is arranged in a parallel manner opposite the connection face on the coupler housing of the rapid couplers of the first type, wherein the two corresponding coupler cartridges are arranged opposite the joining face in a state recessed in the coupler housing, wherein they are accessible in the region of the joining face for connecting a counter-piece, wherein the spacing between the connection and joining face in the direction of the vertical axis is constructed to be identical on all rapid couplers of the first type, wherein at least two rapid couplers of the first type have different coupler cartridges.

There may be provision for each coupler cartridge of a rapid coupler of the first type to be associated with a protective cap, which at least indirectly abuts the joining face, wherein it can be pivoted relative to a first rotation axis which is arranged parallel with the vertical axis, wherein it completely covers the associated coupler cartridge in at least one pivot position, wherein all protective caps are constructed identically, regardless of the type of the associated coupler cartridge. The protective cap may rest directly on the joining face. However, it is also conceivable for both protective caps of a rapid coupler to be secured to a common plate-like intermediate portion, wherein the intermediate portion rests on the joining face.

There may be provision for the rapid couplers of the first type to each have at least one actuation lever, wherein all the actuation levers are constructed to be identical with regard to their shape which is visible from the outer side, wherein each actuation lever has a second rotation axis which is arranged parallel with the transverse axis, wherein the spacing between the second rotation axis and the associated connection face, in the case of at least two actuation levers which are associated with different coupler cartridges, is constructed to be different. Preferably, the rapid couplers of the first type have two actuation levers which are arranged with respect to the transverse axis at opposing sides of the coupler housing. The two actuation levers may be connected to each other in a rotationally secure manner so that with both actuation levers both coupler cartridges can be activated at the same time. However, it is also conceivable for the two actuation levers to be able to be pivoted independently of each other, wherein one of the two coupler cartridges is associated with each actuation lever. When a plurality of any rapid couplers of the first type are combined to form a subassembly, all actuation levers have in the direction of the longitudinal axis a spacing which is equal to the spacing separation. This spacing is preferably measured at the second rotation axis.

There may be provision for the coupler housing of the rapid couplers of the first type to each have a flange portion and a cartridge portion which are arranged beside each other in the direction of the vertical axis, wherein they are delimited from each other by means of a first recess which is arranged externally on the coupler housing, wherein the coupler cartridges are received in the cartridge portion, wherein the connection face is arranged on the flange portion, wherein the securing apertures comprise at least a first securing aperture which extends through the flange portion, wherein it opens in the first recess. Accordingly, via the first recess, a securing means, for example, a screw bolt, can be introduced into the first securing aperture. The joining face is preferably arranged on the cartridge portion.

There may be provision for there to be arranged externally on the cartridge portion at least one second recess which extends in the direction of the vertical axis over the entire height of the cartridge portion, wherein it opens in the first recess, wherein the second recess is arranged in such a manner that, when viewed in the direction of the vertical axis, the view of an associated first securing aperture is not blocked by the coupler housing. The second recess preferably has a constant cross-sectional shape along the vertical axis. Preferably, a second recess is associated with all first securing apertures. The second recesses are preferably a component of a blank of the coupler housing which is produced extremely preferably using a casting method.

There may be provision for the rapid couplers of the first type to comprise a first subtype, in which the first recess is constructed so as to extend continuously with respect to the vertical axis around the coupler housing, wherein all the securing apertures are first securing apertures. Preferably, a first recess is associated with all first securing apertures. The rapid couplers of the first subtype are preferably provided with coupler cartridges of a first type, which have a size which is reduced compared with the largest coupler cartridge (second or third type) of the range. For example, they have the nominal size of ½ inch.

There may be provision for the rapid couplers of the first type to comprise a second subtype, in which the coupler housing has a planar side face, which is a component of the flange portion and the cartridge portion, wherein it is constructed in a coherent manner, wherein the securing apertures comprise a second securing aperture, which is arranged in the region of the mentioned side face, wherein it extends over the entire height of the coupler housing. The second securing apertures are preferably produced by means of drilling. The rapid couplers of the second subtype are preferably provided with the largest coupler cartridges (second or third type) of the range. For example, they have the nominal size of ¾ inch. The at least one second securing aperture is preferably provided with a recess in the region of the joining face. The mentioned side face is preferably not divided into two separate part-faces by the first recess.

There may be provision on each coupler cartridge at a first leakage location and a separate second leakage location for leakage oil to be able to be discharged, wherein the second leakage locations are permanently connected in fluid terms to the associated leakage oil connection, wherein the first leakage locations are connected to a leakage oil channel which extends through the coupler housing in the direction of the longitudinal axis so that the leakage oil channels produce a continuous channel when any rapid couplers of the range are combined along the longitudinal axis to form a subassembly. The second leakage location preferably guides clean leakage oil, which can be further used in the hydraulic circuit. The first leakage location is preferably arranged in the region of the joining face, wherein, when the coupler cartridges are coupled or uncoupled, there may occur at that location contaminated leakage oil, which should no longer be introduced into the hydraulic circuit, wherein it is instead collected in a separate container.

There may be provision for a mouth opening in the joining face to be associated with each coupler cartridge of a rapid coupler of the first type, wherein at the edge of the mouth opening there is arranged a third recess which extends with a constant cross-sectional shape in the direction of the vertical axis, wherein it is connected in fluid terms to the leakage oil channel.

There may be provision for the mouth opening to be defined by a circular-cylindrical fourth recess, which is arranged concentrically relative to the associated coupler cartridge, wherein the coupler cartridge is arranged flush with a base of the fourth recess or protrudes into the fourth recess. The fourth recess serves to collect the leakage oil from the first leakage location. Furthermore, as a result of appropriate selection of the depth of the fourth recess, the position of the second rotation axis relative to the connection face in all rapid couplers of the first type can be constructed in an identical manner.

There may be provision for the range to comprise at least one rapid coupler of the second type, wherein the corresponding coupler cartridges each have an actuation means, by way of which the coupling engagement can be released or produced, wherein the corresponding coupler housing is constructed in a plate-like manner, wherein the mentioned coupler cartridges are screwed to the coupler housing from the outer side. The actuation means may be a linearly movable actuation sleeve. Coupler cartridges with a linearly movable actuation sleeve are also referred to as coupler cartridges in push-pull technology. The coupler housing of the rapid couplers of the second type is preferably constructed in a similar manner to the flange portion of the coupler housing of the rapid couplers of the first type. The actuation means may also be a pivotably movable lever. The corresponding coupler cartridges are also referred to as “semi-integrated”.

Of course, the features mentioned above and those explained below may also be used not only in the combination given, but also in other combinations or alone without departing from the scope of the present disclosure.

### BRIEF DESCRIPTION OF THE DRAWINGS

The disclosure is explained in greater detail below with reference to the appended drawings, in which:

FIG. 1 is a perspective view of a subassembly with all the rapid couplers of the range according to the disclosure;

FIG. 2 is another perspective view of the subassembly according to FIG. 1 from a side opposite FIG. 1;

FIG. 3 is a perspective view of a rapid coupler of the first subtype;

FIG. 4 is a perspective view of a rapid coupler of the second subtype;

FIG. 5 is a perspective view of an intermediate portion with two protective caps.

### DETAILED DESCRIPTION

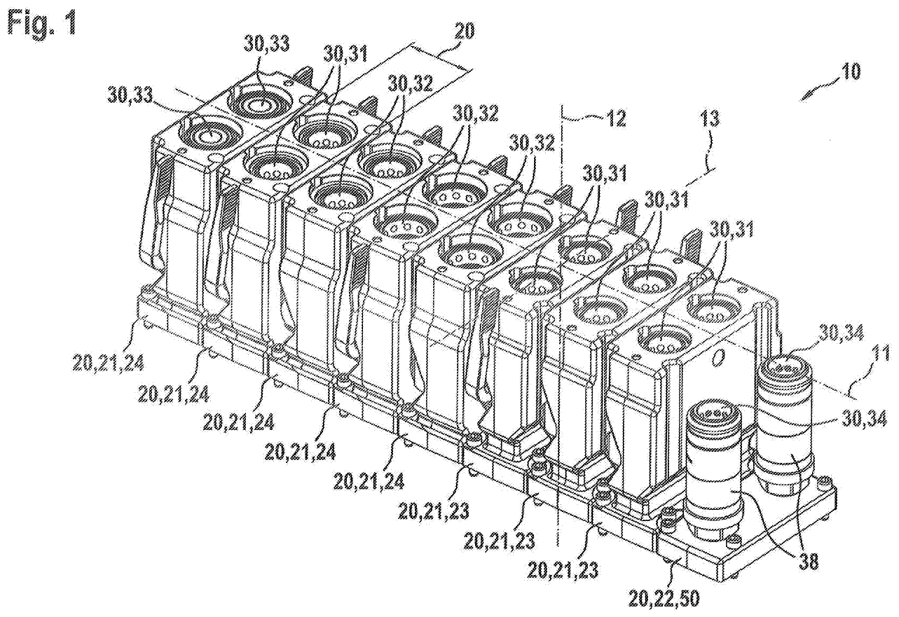

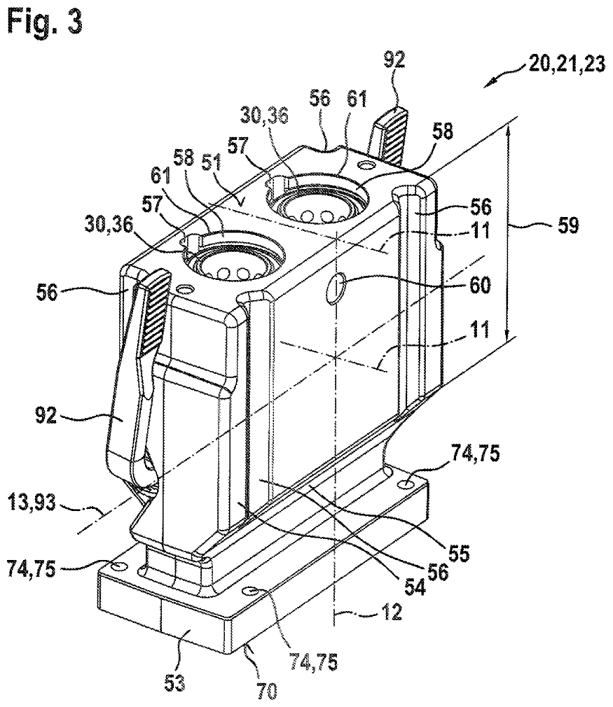

FIG. 1 is a perspective view of a subassembly 10 with all rapid couplers 20; 21; 22; 23; 24 of the range according to the disclosure. The rapid couplers 20 are arranged beside each other in the direction of a longitudinal axis 11 with a constant spacing separation 14. This spacing separation 14 is identical to the spacing separation of the valve block on which the present subassembly is intended to be installed. Most rapid couplers are constructed according to a first type 21 which comprises in each case one or two actuation levers (No. 92 in FIGS. 3; 4) which are arranged in the direction of a transverse axis 13 at opposing sides of the associated coupler housing (No. 50 in FIGS. 3; 4). All the actuation levers are constructed to be identical with respect to the shape and arrangement thereof visible from the outer side on the coupler housing, wherein only their position in the direction of the vertical axis 12 may be different as a result of the coupler cartridge 31; 32; 33 which is used in each case. The vertical axis 12 is orientated perpendicularly to the longitudinal axis 11, wherein the transverse axis 13 is orientated perpendicularly to the longitudinal axis and vertical axis 11; 12.

The rapid couplers of the first type 21 comprise a plurality of rapid couplers of a first subtype 23. This is provided in each case with two female coupler cartridges 31 of the nominal size ½ inch. This is commercially by far the most requested variant of the rapid coupler 20. It is accordingly constructed in a particularly cost-effective manner. In particular, on the cast blank of the coupler housing only little machining post-processing is required, wherein the coupler housing is constructed in a particularly material-saving manner.

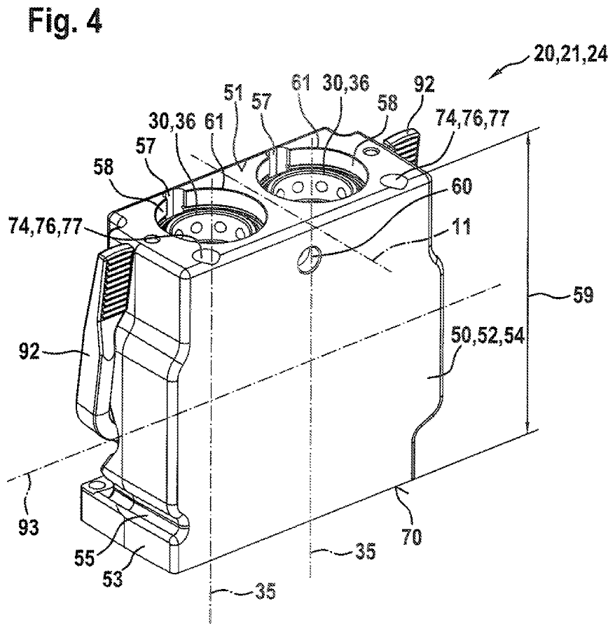

The rapid couplers of the first type 21 comprise a plurality of rapid couplers of a second subtype 24. This is in particular adapted to large coupler cartridges 32; 33 of the nominal size ¾ inch. These coupler cartridges may be constructed in a female variant 32 or in a flat-face variant 33. However, it is also conceivable for a coupler cartridge 31 of the nominal size ½ inch to be installed in a rapid coupler of the second subtype 24, particularly if later in the field when changing to larger couplers, for example, from ½″ to ¾″, only the coupler cartridge is intended to be replaced. With regard to further details, reference may be made to the statements relating to FIG. 4.

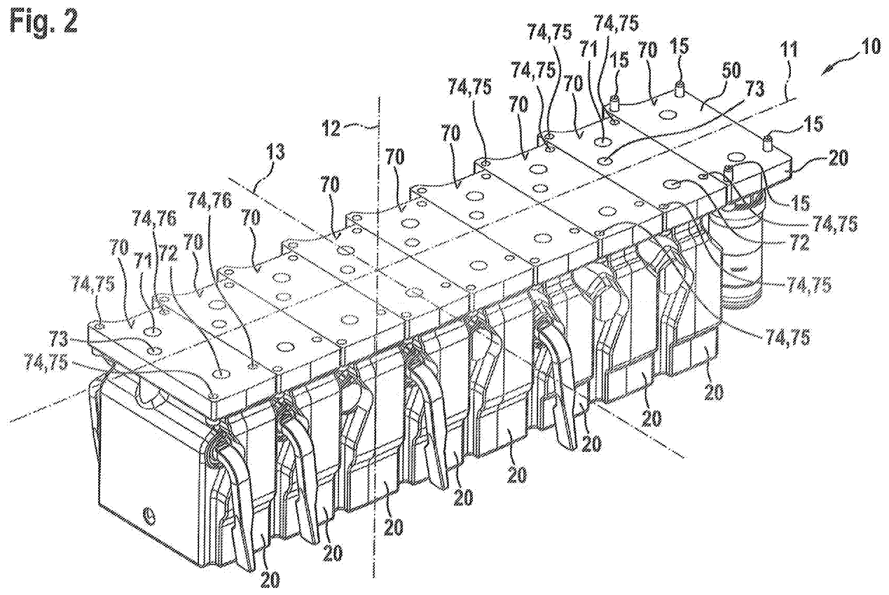

Furthermore, the subassembly 10 comprises a rapid coupler of the second type 22. The coupler housing 50 thereof is constructed in accordance with the flange portion (No. 53 in FIGS. 3; 4) of the rapid coupler of the first type 21, wherein no leakage oil connection (No. 73 in FIG. 2) is provided. Two coupler cartridges 34 are screwed in the corresponding coupler housing 50 using push-pull technology. They have in each case in place of the actuation levers (No. 92 in FIG. 3; 4) an actuation means 38 in the form of an actuation sleeve which can be moved parallel with the vertical axis 12 in order to produce and release the coupling engagement. The rapid coupler of the second type 22 is the most cost-effective of all rapid couplers 20. The range according to the disclosure has in this regard the advantage that the associated valve disc does not have to be changed in any way in order to also be able to use this variant.

FIG. 2 is another perspective view of the subassembly 10 according to FIG. 1, from a side opposite FIG. 1. It is possible to see the connection face 70 of each rapid coupler 20. All connection faces 70 are constructed in a planar manner and orientated parallel with the longitudinal axis 11. With the completely mounted subassembly 10, they are all located in one plane. The coupler housings (No. 50 in FIGS. 3; 4) adjoin each other in the region of the connection face 70 thereof preferably with little play so that they can be easily orientated relative to the valve block. The corresponding opposing contact faces are preferably constructed in a planar manner and orientated perpendicularly to the longitudinal axis 11.

Within each connection face 70, for each rapid coupler 20 a first and a second working connection 71; 72 and four securing apertures 74 are arranged. Only with the rapid couplers of the first type is a leakage oil connection 73 further provided. These interface contours 71; 72; 73; 74 are constructed identically and arranged identically in all rapid couplers 20 so that the rapid couplers 20 can be replaced with respect to each other as desired.

The securing apertures 74 can be constructed as first or as second securing apertures 75; 76. Securing means 15 in the form of short screw bolts extend in each case through the short first securing apertures 75. The longer second securing apertures 76 are the reason for the tight structural space. Correspondingly long securing means in the form of screw bolts extend through them. Of course, other securing means, such as furniture closures, stay bolts with recesses and pins or stud screws can also be used from the side. The securing apertures 74 can further be provided with an inner thread so that screw bolts can be screwed in at that location.

FIG. 3 is a perspective view of a rapid coupler of the first subtype 23. The coupler housing 50 comprises a flange portion 53 and a cartridge portion 54 which are arranged beside each other in the direction of the vertical axis 12, wherein they are delimited from each other by means of a first recess 55. The connection face 70 is arranged at the bottom on the flange portion 53, wherein the coupler cartridges 30 are received inside the cartridge portion 54. The coupler cartridges 30 are preferably constructed in accordance with a first type 31, which is of the nominal size ½ inch.

The first recess 55 is constructed with respect to the vertical axis 12 so as to extend continuously around the coupler housing 50. Accordingly, all four securing apertures 74 open in the first recess 55 so that they are first securing apertures 75. Subsequently, the securing means can be introduced via the first recess 55 into the first securing apertures 75. The securing means are, for example, cylinder head screws having an internal hexagon socket or having a Torx profile. The corresponding screw tool is positioned via second recesses 56 which are arranged externally on the cartridge portion 54. The second recesses 56 extend with a constant cross-sectional shape in the direction of the vertical axis 12 over the entire height of the cartridge portion 54. They are arranged in alignment with an associated first securing aperture 75. The mentioned screw tool can consequently readily be orientated parallel with the vertical axis 12 while it is placed on the securing means.

It is further possible to see in FIG. 3 the two actuation levers 92 which are arranged in the direction of the transverse axis 13 at opposing sides of the coupler housing 50. The actuation levers 92 can be pivoted with respect to a second rotation axis 93 which is orientated parallel with the transverse axis 13. It is conceivable for both actuation levers 92 to be connected to each other in a rotationally secure manner, wherein they are then preferably orientated parallel with each other. In this instance, both coupler cartridges 30 can be activated at the same time with each of the two actuation levers. It is also conceivable for the two actuation levers 92 to be able to be pivoted independently of each other. In this instance, each actuation lever preferably activates the next coupler cartridge in each case. Furthermore, a single common actuation lever for both coupler cartridges is conceivable.

The two coupler cartridges 30 are in each case arranged in a state recessed with respect to the joining face 51 in the cartridge portion 54. In this instance, the coupler housing 50 has a circular-cylindrical fourth recess 58 which is arranged concentrically relative to the associated coupler cartridge 30. In this region there is a first leakage location 36 at which there may occur, when the coupler cartridge 30 is coupled or uncoupled, leakage oil which is often contaminated so that it should be disposed of. This leakage oil accumulates in the fourth recess 58. At the edge of the mouth opening 61 defined by the fourth recess 58, there is arranged a third recess which extends parallel with the vertical axis 12 with a constant cross-sectional shape. The fourth recesses 57 are connected in fluid terms to a leakage oil channel 60 which extends through the coupler housing 50 between the two coupler cartridges 30 in the direction of the longitudinal axis 11. When the rapid couplers 20 are combined to form a subassembly, there is produced from the individual leakage oil channels 60 a channel which extends in the direction of the longitudinal axis 11 and which is preferably connected to a collecting container in which the leakage oil of the first leakage locations is collected in order to dispose of it.

The height of the rapid coupler 20 is further illustrated in FIG. 3, that is to say, the spacing 59 between the planar connection face 70 and the parallel, planar joining face 51. This height is preferably constructed to be identical in all rapid couplers of the first type.

FIG. 4 is a perspective view of a rapid coupler of the second subtype 24. The rapid coupler of the second subtype 24 is, with the exception of the differences explained below, constructed identically to the rapid coupler of the first subtype so that in this regard reference may be made to the statements in relation to FIGS. 1 to 3. In FIGS. 1 to 4, identical or corresponding components are given the same reference numerals.

The rapid coupler of the second subtype 24 has a coupler housing 50 having a planar side face 52 which is orientated perpendicularly to the longitudinal axis (No. 11 in FIG. 1). The side face 52 is constructed to be coherent, wherein it is in particular not interrupted by the first recess 55. The first recess 55 accordingly extends in a U-shaped manner externally on the coupler housing 50. More space is thereby available inside the coupler housing 50 for large coupler cartridges 30, for example, of the nominal size ¾ inch. In this instance, in particular the structural space which is available in the direction of the vertical axis (No. 12 in FIG. 12) is increased. In FIG. 4, nonetheless only a smaller coupler cartridge of the nominal size ½ inch is shown. In this variant, subsequent retrofitting to a larger ¾ inch coupler cartridge is possible.

The two securing apertures 74 in the region of the side face 52 are constructed as second securing apertures 76, which extend through the coupler housing 50 over the entire height thereof. In the region of the joining face 51, the second securing apertures 76 are provided with a recess 77. The second securing apertures 76 are preferably produced by means of an expensive drilling processing operation, for which reason the rapid coupler according to the second subtype 24 is used only when this is absolutely necessary as a result of the structural space required inside the rapid coupler 20.

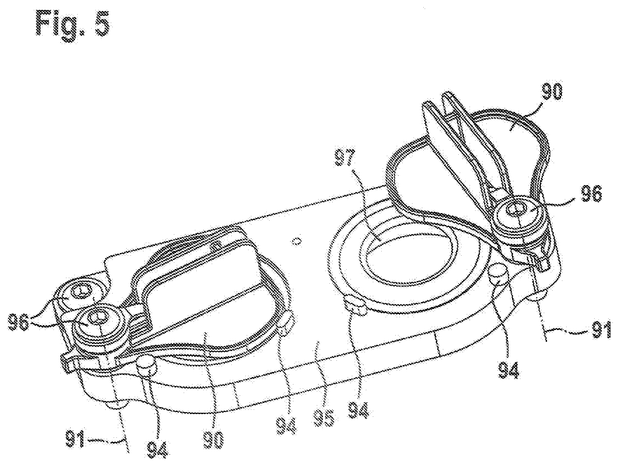

FIG. 5 is a perspective view of an intermediate portion 95 with two protective caps 90. The intermediate portion 95 is constructed in a plate-like manner, wherein it is preferably produced from plastics material using an injection-molding method. With the planar lower side thereof, it rests on the joining face (No. 51 in FIG. 3 or 4), wherein it can be secured at that location by means of screw bolts 96. Two of the screw bolts 96 form at the same time a rotary joint, whose first rotation axis 91 is arranged parallel with the vertical axis (No. 12 in FIG. 1). The two protective caps 90 can be pivoted relative to the first rotation axis 91. In the closed position which is defined by means of end stops 94, they cover an associated aperture 97 in the intermediate portion 95 which is arranged concentrically relative to the associated coupler cartridge (No. 30 in FIGS. 3; 4). The diameter of the aperture 97 is preferably constructed to be smaller than the diameter of the fourth recess so that the leakage oil of the first leakage location is prevented from escaping. Of course, the hydraulic hose which is intended to be coupled should still be able to be introduced through the aperture 97. This aperture 97 can optionally be adapted by means of a rubber bush to the hydraulic hose which is intended to be coupled.

An advantage of the range according to the disclosure is that the subassembly illustrated in FIG. 5 can be used identically in all variants of the rapid coupler of the first type.

### LIST OF REFERENCE NUMERALS

10 Subassembly comprising a plurality of rapid couplers of the range
11 Longitudinal axis
12 Vertical axis
13 Transverse axis
14 Spacing separation
15 Securing means
20 Rapid coupler
21 Rapid coupler of the first type
22 Rapid coupler of the second type
23 Rapid coupler of the first subtype
24 Rapid coupler of the second subtype
30 Coupler cartridge
31 Coupler cartridge of the first type (nominal size ½ inch)
32 Coupler cartridge of the second type (nominal size ¾ inch)
33 Coupler cartridge of the third type (nominal size ¾ inch, flat face variant)
34 Coupler cartridge of the fourth type (push-pull technology)
35 Center axis of a coupler cartridge
36 First leakage location
38 Activation means
50 Coupler housing
51 Joining face
52 Side face
53 Flange portion
54 Cartridge portion
55 First recess
56 Second recess
57 Third recess
58 Fourth recess
59 Spacing between connection face and joining face
60 Leakage oil channel
61 Mouth opening
70 Connection face
71 First working connection
72 Second working connection
73 Leakage oil connection
74 Securing aperture
75 First securing aperture
76 Second securing aperture
77 Recess
90 Protective cap
91 First rotation axis of the protective cap
92 Actuation lever
93 Second rotation axis of the actuation lever
94 End stop
95 Intermediate portion
96 Screw bolt
97 Aperture

What is claimed is:

1. A range, comprising:
a plurality of rapid couplers, each rapid coupler including:
a coupler housing having a planar connection face,
two coupler cartridges secured in or on the coupler housing,
a longitudinal axis arranged parallel with the connection face, a vertical axis arranged perpendicularly to the connection face, and a transverse axis arranged perpendicularly to the longitudinal axis and the vertical axis, and
a first working connection, a second working connection, and a plurality of securing apertures arranged within the connection face of the coupler housing, the first and second working connections connected in fluid terms to an associated coupler cartridge,
wherein all the coupler housings are configured integrally, wherein all the coupler cartridges are each secured directly in or on the associated coupler housing, wherein the first and second working connections and the securing apertures are configured in an identical manner in all the rapid couplers with respect to their shape and their relative position inside the associated connection face, wherein at least two rapid couplers of the range have different coupler cartridges, and wherein all the coupler housings are configured to be arranged with respect to the longitudinal axis beside each other with a constant spacing separation that is identical for all the rapid couplers of the range.

2. The range according to claim 1, wherein the plurality of rapid couplers includes a plurality of rapid couplers of a first type, wherein a joining face is arranged on the coupler housing of the rapid couplers of the first type in a parallel manner opposite the connection face, wherein the two corresponding coupler cartridges are arranged opposite the joining face in a state recessed in the coupler housing, wherein the two corresponding coupler cartridges are accessible in the region of the joining face so as to connect a counter-piece, wherein the spacing between the connection and the joining face in the direction of the vertical axis is configured to be identical on all rapid couplers of the first type, and wherein at least two rapid couplers of the first type have different coupler cartridges.

3. The range according to claim 2, wherein each coupler cartridge of a rapid coupler of the first type is associated with a protective cap that at least indirectly abuts the joining face, wherein the protective cap is configured be pivoted relative to a first rotation axis that is arranged parallel with the vertical axis, wherein the protective cap completely covers the associated coupler cartridge in at least one pivot position, and wherein all the protective caps are configured identically regardless of the type of the associated coupler cartridge.

4. The range according to claim 2, wherein the rapid couplers of the first type each have at least one actuation lever, wherein all the actuation levers are configured to be identical with regard to their shape which is visible from the outer side, wherein each actuation lever has a second rotation axis that is arranged parallel with the transverse axis, and wherein the spacing between the second rotation axis and the associated connection face, in the case of at least two actuation levers which are associated with different coupler cartridges, is configured to be different.

5. The range according to claim 2, wherein the coupler housing of the rapid couplers of the first type each have a flange portion and a cartridge portion that are arranged beside each other in the direction of the vertical axis, wherein the flange portion and the cartridge portion are delimited from each other by a first recess that is arranged externally on the coupler housing, wherein the coupler cartridges are received in the cartridge portion, wherein the connection face is arranged on the flange portion, and wherein the securing apertures comprise at least a first securing aperture that extends through the flange portion and opens in the first recess.

6. The range according to claim 5, wherein at least one second recess is arranged externally on the cartridge portion and extends in the direction of the vertical axis over an entire height of the cartridge portion, wherein the second recess opens in the first recess, and wherein the second recess is arranged such that, when viewed in the direction of the vertical axis, the view of an associated first securing aperture is not blocked by the coupler housing.

7. The range according to claim 5, wherein the rapid couplers of the first type comprise a first subtype, in which the first recess is configured so as to extend continuously with respect to the vertical axis around the coupler housing, and wherein all the securing apertures are first securing apertures.

8. The range according to claim 5, wherein the rapid couplers of the first type comprise a second subtype in which the coupler housing has a planar side face, which is a component of the flange portion and the cartridge portion, wherein the planar side face is configured in a coherent manner, and wherein the securing apertures comprise a second securing aperture that is arranged in a region of the planar side face and extends over an entire height of the coupler housing.

9. The range according to claim 2, wherein each rapid coupler includes a leakage oil connection arranged within the connection face of the coupler housing, and wherein the leakage oil connections are configured in an identical manner in all rapid couplers with respect to their shape and their relative position inside the associated connection face.

10. The range according to claim 9, wherein on each coupler cartridge leakage oil is configured to be discharged at a first leakage location and a separate second leakage location, wherein the second leakage locations are permanently connected in fluid terms to the associated leakage oil connection, wherein the first leakage locations are connected to a leakage oil channel that extends through the coupler housing in the direction of the longitudinal axis so that the leakage oil channels define a continuous channel when any rapid couplers of the range are combined along the longitudinal axis to form a subassembly.

11. The range according to claim 10, wherein a mouth opening in the joining face is associated with each coupler cartridge of a rapid coupler of the first type, wherein a third recess is arranged at an edge of the mouth opening and extends with a constant cross-sectional shape in the direction of the vertical axis, and wherein the third recess is connected in fluid terms to the leakage oil channel.

12. The range according to claim 11, wherein the mouth opening is defined by a circular-cylindrical fourth recess that is arranged concentrically relative to the associated coupler cartridge, and wherein the coupler cartridge is arranged flush with a base of the fourth recess or protrudes into the fourth recess.

13. The range according to claim 1, wherein the plurality of rapid couplers includes at least one rapid coupler of a second type, wherein corresponding coupler cartridges of the at least one rapid coupler of the second type each have an actuation mechanism by way of which a coupling engagement is configured to be released or produced, wherein the corresponding coupler housing of the at least one rapid coupler of the second type is configured in a plate-like manner, and wherein the corresponding coupler cartridges are screwed to the coupler housing from the outer side.
